(19) United States
(12) Patent Application Publication
(10) Pub. No.: US 2017/0194815 A1
(43) Pub. Date: Jul. 6, 2017

(54) UNIFIED INDUCTIVE DIGITAL PROTOCOL

(71) Applicant: POWERMAT TECHNOLOGIES LTD., Neve Ilan (IL)

(72) Inventors: Elieser MACH, Rosh Tzurim (IL); Yuval KOREN, Rehovot (IL); Guy RAVEH, Mata (IL); Oz MOSHKOVICH, Rehovot (IL)

(21) Appl. No.: 15/309,632

(22) PCT Filed: May 8, 2015
(86) PCT No.: PCT/IB15/00879

§ 371 Date: Nov. 8, 2016

Related U.S. Application Data
(60) Provisional application No. 61/990,117, filed on May 8, 2014.

(51) Int. Cl. H02J 50/12; H02J 50/80

(52) U.S. Cl. CPC H02J 50/12; H02J 50/80

(57) ABSTRACT

A wireless power receiver, configured to inductively receive power from a wireless power outlet for powering a load, and to encode a signal for detection by the wireless power outlet, is provided. The wireless power receiver comprising a receiver circuit having a secondary coil connected to the load and configured to receive power from a primary coil associated with the wireless power outlet, and a resonance adjuster electrically connected to the secondary coil and configured to adjust the resonant frequency of the receiver circuit, between one of two resonant frequencies, by selectively modifying the receiver circuit. The wireless power receiver further comprises a controller configured to operate the resonance adjuster to encode the signal by adjusting the resonant frequency of the receiver circuit, wherein the signal comprises a plurality of data blocks carrying information, alternating with a plurality of power blocks each carrying a power instruction.

### CROSS-REFERENCE TO RELATED APPLICATIONS

This application claims the benefit of U.S. provisional application Ser. No. 61/990,117 filed May 8, 2014, the disclosure of which is hereby incorporated in its entirety by reference herein.

### TECHNICAL FIELD

The present disclosure relates to wireless power systems. In particular, it relates to transmission of information from a receiver to an outlet thereof.

### BACKGROUND

The use of a wireless non-contact system for the purposes of automatic identification or tracking of items is an increasingly important and popular functionality.

Inductive power coupling allows energy to be transferred from a power supply to an electric load without a wired connection therebetween. An oscillating electric potential is applied across a primary inductor. This sets up an oscillating magnetic field in the vicinity of the primary inductor. The oscillating magnetic field may induce a secondary oscillating electrical potential in a secondary inductor placed close to the primary inductor. In this way, electrical energy may be transmitted from the primary inductor to the secondary inductor by electromagnetic induction without a conductive connection between the inductors.

When electrical energy is transferred from a primary inductor to a secondary inductor, the inductors are said to be inductively coupled. An electric load wired in series with such a secondary inductor may draw energy from the power source wired to the primary inductor when the secondary inductor is inductively coupled thereto.

### SUMMARY

According to one aspect of the presently disclosed subject matter, there is provided a wireless power receiver configured to inductively receive power from a wireless power outlet for powering a load, and configured to encode a signal for detection by the wireless power outlet, the wireless power receiver comprising a receiver circuit having: a secondary coil connected to the load and configured to receive power from a primary coil associated with the wireless power outlet; and a resonance adjuster electrically connected to the secondary coil and configured to adjust the resonant frequency of the receiver circuit, between one of two resonant frequencies, by selectively modifying the receiver circuit; the wireless power receiver further comprising a controller configured to operate the resonance adjuster to encode the signal by adjusting the resonant frequency of the receiver circuit, wherein the signal comprises a plurality of data blocks carrying information, alternating with a plurality of power blocks each carrying a power instruction.

According to one aspect of the presently disclosed subject matter, there is provided a wireless power receiver configured to inductively receive power from a wireless power outlet for powering a load, and configured to encode a signal for detection by the wireless power outlet, the wireless power receiver comprising a receiver circuit having: a secondary coil connected to the load and configured to receive power from a primary coil associated with the wireless power outlet; and a resonance adjuster electrically connected to the secondary coil and configured to adjust the resonant frequency of the receiver circuit, between one of two resonant frequencies, by selectively modifying the receiver circuit; the wireless power receiver further comprising a controller configured to operate the resonance adjuster to encode the signal by adjusting the resonant frequency of the receiver circuit, wherein the signal comprises a plurality of data blocks carrying information, alternating with a plurality of power blocks each carrying a power instruction.

Each of the power instructions may be selected from the group consisting of: to increase the operating frequency of the wireless power outlet; to decrease the operating frequency of the wireless power outlet; and to continue operation of the wireless power outlet with no change in operating frequency.

The controller may be configured to: operate the state modifier to encode a first type of power block by keeping the state of the receiver circuit constant for the duration of the power block; operate the state modifier to encode a second type of power block by changing the state of the receiver circuit between the two resonant frequencies one time during the duration of the power block; and operate the state modifier to encode a third type of power block by changing the state of the receiver circuit between the two resonant frequencies two or more times during the duration of the power block.

The controller may be configured to operate the state modifier to encode the third type of power block by changing the state of the receiver circuit between the two states at a rate of 8 kHz.

The controller may be configured to operate the state modifier to encode the third type of power block by changing the state of the receiver circuit between the two states seven times during the duration of the power block.

The controller may be configured to operate the state modifier to encode the second type of power block by changing the state of the receiver circuit between the two states at a rate of 2 kHz.

The duration (i.e., the length) of the power block may be about 500 microseconds.

Each of the data blocks and power blocks may be of the same time duration.

The state modifier may comprise a resonance adjuster such as a circuit element and a switching element configured to modify the receiver circuit by selectively connecting/disconnecting the circuit element to/from the receiver circuit, thereby adjusting the resonant frequency thereof. The circuit element may be selected from the group consisting of a resistor, a capacitor, and an inductor.

The controller may be configured to operate the resonance adjuster to adjust the resonant frequency of the receiver circuit by directing operation of the switching element.

The wireless power receiver may be configured to be in communication with a host for supplying power thereto, and receiving information therefrom relating to the data and power blocks. The power instructions may be based on power requirements of the host.

The signal may comprise a preamble immediately preceding the data and power blocks. The preamble may be of a predetermined length.

At least the first one or two data blocks of the signal may constitute a data header. A portion of the data blocks may constitute a data payload of the signal.

The signal may comprise a checksum after the data and power blocks.

According to another aspect of the presently disclosed subject matter, there is provided a method of encoding a signal, the method comprising: providing a wireless power receiver having a receiver circuit comprising a state modifier configured to adjust the state of the receiver circuit, between one of two states, by selectively modifying the receiver circuit; and encoding the signal by operating the state modifier to adjust a circuit characteristic of the receiver circuit; wherein the signal comprises a plurality of data blocks carrying information alternating with a plurality of power blocks each carrying a power instructions.

According to another aspect of the presently disclosed subject matter, there is provided a method of encoding a signal, the method comprising: providing a wireless power receiver having a receiver circuit comprising a resonance adjuster configured to adjust the resonant frequency of the receiver circuit, between one of two resonant frequencies, by selectively modifying the receiver circuit; and encoding the signal by operating the resonance adjuster to adjust the resonant frequency of the receiver circuit; wherein the signal comprises a plurality of data blocks carrying information alternating with a plurality of power blocks each carrying a power instructions.

Each of the power instructions may be selected from the group consisting of: to increase the operating frequency of the wireless power outlet; to decrease the operating frequency of the wireless power outlet; and to continue operation of the wireless power outlet with no change in operating frequency.

The method may further be characterized in that: encoding a first type of power block comprises keeping the resonant frequency of the receiver circuit constant for the duration of the power block; encoding a second type of power block comprises changing the resonant frequency of the receiver circuit between the two resonant frequencies one time during the duration of the power block; and encoding a third type of power block comprises by changing the resonant frequency of the receiver circuit between the two resonant frequencies two or more times during the duration of the power block.

Encoding the third type of power block may comprise changing the resonant frequency of the receiver circuit between the two resonant frequencies at a rate of 8 kHz.

Encoding the third type of power block may comprise changing the resonant frequency of the receiver circuit between the two resonant frequencies seven times during the duration of the power block.

Encoding the second type of power block may comprise changing the resonant frequency of the receiver circuit between the two resonant frequencies at a rate of 2 kHz.

The duration (i.e., the length) of the power block may be about 500 microseconds.

Each of the data blocks and power blocks may be of the same time duration.

The resonance adjuster may comprise a circuit element and a switching element configured to modify the receiver circuit by selectively connecting/disconnecting the circuit element to/from the receiver circuit, thereby adjusting the resonant frequency thereof. The circuit element may be selected from the group consisting of a resistor, a capacitor, and an inductor.

The controller may be configured to operate the resonance adjuster to adjust the resonant frequency of the receiver circuit by directing operation of the switching element.

The wireless power receiver may be configured to be in communication with a host for supplying power thereto, and receiving information therefrom relating to the data and power blocks. The power instructions may be based on power requirements of the host.

The signal may comprise a preamble immediately preceding the data and power blocks. The preamble may be of a predetermined length.

At least the first one or two data blocks of the signal may constitute a data header. A portion of the data blocks may constitute a data payload of the signal.

The signal may comprise a checksum after the data and power blocks.

According to a further aspect of the presently disclosed subject matter, there is provided a wireless power outlet configured to transmit power to a wireless power receiver via a receiver circuit thereof, and to detect a signal transmitted thereby, the wireless power outlet: comprising a primary inductive coil wired to a power source comprising a driver configured to provide an oscillating driving voltage to the primary inductive coil; and being configured to detect a change in a resonant frequency of the receiver circuit when a secondary inductive coil thereof is inductively coupled with the primary inductive coil; the wireless power outlet further comprising a controller configured to direct operation thereof, and to decode a signal encoded in patterns of the resonant frequency of the receiver circuit, wherein the signal comprises a plurality of data blocks carrying information, alternating with a plurality of power blocks each carrying a power instruction.

The controller may be further configured to direct the wireless power outlet to transmit power in accordance with the power instructions upon decoding thereof.

Each of the power instructions may be selected from the group consisting of: to increase the operating frequency of the wireless power outlet; to decrease the operating frequency of the wireless power outlet; and to continue operation of the wireless power outlet with no change in operating frequency.

The controller may be configured to: decode a first type of power block wherein the resonant frequency of the receiver circuit is detected as being constant for the duration of the power block; decode a second type of power block wherein the resonant frequency of the receiver circuit is detected as changing between two resonant frequencies one time during the duration of the power block; and decode a third type of power block wherein the resonant frequency of the receiver circuit is detected as changing between two resonant frequencies two or more times during the duration of the power block; and

The controller may be configured to decode the third type of power block wherein the resonant frequency of the receiver circuit is detected as changing between two resonant frequencies at a rate of 8 kHz.

The controller may be configured to decode the third type of power block wherein the controller is configured to decode the third type of power block wherein the resonant frequency of the receiver circuit is detected as changing between two resonant frequencies seven times during the duration of the power block.

The controller may be configured to decode the second type of power block wherein the controller is configured to decode the second type of power block wherein the resonant frequency of the receiver circuit is detected as changing between two resonant frequencies at a rate of 2 kHz.

The duration (i.e., the length) of the power block may be about 500 microseconds.

Each of the data blocks and power blocks may be of the same time duration.

The signal may comprise a preamble immediately preceding the data and power blocks. The preamble may be of a predetermined length.

The preamble may be of a predetermined length.

At least the first one or two data blocks of the signal may constitute a data header. A portion of the data blocks may constitute a data payload of the signal.

The signal may comprise a checksum after the data and power blocks.

According to a still further aspect of the presently disclosed subject matter, there is provided a method of decoding a signal, the method comprising: providing a wireless power outlet having a primary inductive coil wired to a power source comprising a driver configured to provide an oscillating driving voltage to the primary inductive coil; detecting a change in a resonant frequency of a receiver circuit having a secondary inductive coil is inductively coupled with the primary inductive coil; and decoding the signal encoded in patterns of the resonant frequency of the receiver circuit; wherein the signal comprises a plurality of data blocks carrying information, alternating with a plurality of power blocks each carrying a power instruction.

The method may further comprise the wireless power outlet transmitting power in accordance with the power instructions upon decoding thereof.

Each of the power instructions may be selected from the group consisting of: to increase the operating frequency of the wireless power outlet; to decrease the operating frequency of the wireless power outlet; and to continue operation of the wireless power outlet with no change in operating frequency.

The method may further be characterized in that: decoding a first type of power block comprises detecting the resonant frequency of the receiver circuit as being constant for the duration of the power block; decoding a second type of power block comprises detecting the resonant frequency of the receiver circuit as changing between two resonant frequencies one time during the duration of the power block; and decoding a third type of power block comprises detecting the resonant frequency of the receiver circuit as changing between two resonant frequencies two or more times during the duration of the power block; and Decoding the third type of power block may comprise detecting the resonant frequency of the receiver circuit as changing between two resonant frequencies at a rate of 8 kHz.

Decoding the third type of power block may comprise detecting the resonant frequency of the receiver circuit as changing between two resonant frequencies seven times during the duration of the power block.

Decoding the second type of power block may comprise detecting the resonant frequency of the receiver circuit as changing between two resonant frequencies at a rate of 2 kHz.

The duration (i.e., the length) of the power block may be about 500 microseconds.

Each of the data blocks and power blocks may be of the same time duration.

The signal may comprise a preamble immediately preceding the data and power blocks.

The preamble may be of a predetermined length.

At least the first one or two data blocks of the signal may constitute a data header. A portion of the data blocks may constitute a data payload of the signal.

The signal may comprise a checksum after the data and power blocks.

According to a still further aspect of the presently disclosed subject matter, there is provided a wireless power system comprising a wireless power receiver and a wireless power outlet, the wireless power receiver being configured to inductively receive power for powering a load, and to encode signals for detection by the wireless power outlet, the wireless power receiver comprising a receiver circuit having: a secondary coil connected to the load and configured to receive power from a primary coil associated with the wireless power outlet; and a resonance adjuster electrically connected to the secondary coil and configured to adjust the resonant frequency of the receiver circuit, between one of two resonant frequencies, by selectively modifying the receiver circuit; the wireless power receiver further comprising a receiver controller configured to operate the resonance adjuster to encode the signal by adjusting the resonant frequency of the receiver circuit, the wireless power outlet being configured to transmit power to the wireless power receiver via the receiver circuit, and to detect signals encoded thereby, the wireless power outlet: comprising a primary inductive coil wired to a power source comprising a driver configured to provide an oscillating driving voltage to the primary inductive coil; and being configured to detect a change in the resonant frequency of the receiver circuit when the secondary inductive coil is inductively coupled with the primary inductive coil; the wireless power outlet further comprising an outlet controller configured to direct operation thereof, and to decode a signal encoded in patterns of the resonant frequency of the receiver circuit, wherein the signal comprises a plurality of data blocks carrying information, alternating with a plurality of power blocks each carrying a power instruction.

The outlet controller may be further configured to direct the wireless power outlet to transmit power in accordance with the power instructions upon decoding thereof.

Each of the power instructions may be selected from the group consisting of: to increase the operating frequency of the wireless power outlet; to decrease the operating frequency of the wireless power outlet; and to continue operation of the wireless power outlet with no change in operating frequency.

The wireless power system may be further characterized in that: the receiver controller is configured to operate the resonance adjuster to encode a first type of power block by keeping the resonant frequency of the receiver circuit constant for the duration of the power block, the outlet controller being configured to decode the first type of power block; the receiver controller is configured to operate the resonance adjuster to encode a second type of power block by changing the resonant frequency of the receiver circuit between the two resonant frequencies one time during the duration of the power block, the outlet controller being configured to decode the second type of power block; and the receiver controller is configured to operate the resonance adjuster to encode a third type of power block by changing the resonant frequency of the receiver circuit between the two resonant frequencies two or more times during the duration of the power block, the outlet controller being configured to decode the third type of power block.

The receiver controller may be configured to operate the resonance adjuster to encode the third type of power block by changing the resonant frequency of the receiver circuit between the two resonant frequencies at a rate of 8 kHz.

The receiver controller may be configured to operate the resonance adjuster to encode the third type of power block by changing the resonant frequency of the receiver circuit between the two resonant frequencies seven times during the duration of the power block.

The receiver controller may be configured to operate the resonance adjuster to encode the second type of power block by changing the resonant frequency of the receiver circuit between the two resonant frequencies at a rate of 2 kHz.

The duration (i.e., the length) of the power block may be about 500 microseconds.

Each of the data blocks and power blocks may be of the same time duration.

The resonance adjuster may comprise a circuit element and a switching element configured to modify the receiver circuit by selectively connecting/disconnecting the circuit element to/from the receiver circuit, thereby adjusting the resonant frequency thereof. The circuit element may be selected from the group consisting of a resistor, a capacitor, and an inductor.

The controller may be configured to operate the resonance adjuster to adjust the resonant frequency of the receiver circuit by directing operation of the switching element.

The wireless power receiver may be configured to be in communication with a host for supplying power thereto, and receiving information therefrom relating to the data and power blocks. The power instructions may be based on power requirements of the host.

The signal may comprise a preamble immediately preceding the data and power blocks. The preamble may be of a predetermined length.

At least the first one or two data blocks of the signal may constitute a data header. A portion of the data blocks may constitute a data payload of the signal.

The signal may comprise a checksum after the data and power blocks.

According to a still further aspect of the presently disclosed subject matter, there is provided a digital signal encoded using high and low values, the digital signal comprising a plurality of data blocks carrying information, alternating with a plurality of power blocks each carrying a power instruction for a wireless power outlet.

It will be appreciated that herein the specification and claims, the terms “high” and “low” in connection with the encoding of the signal are used for convenience only, for example to correlate to a graphical representation thereof, and should not be construed as limiting any property of the signal as being high or low.

Each of the power instructions may be selected from the group consisting of: to increase the operating frequency of the wireless power outlet; to decrease the operating frequency of the wireless power outlet; and to continue operation of the wireless power outlet with no change in operating frequency.

The digital signal may be further characterized in that: a first type of power block is encoded by transmitting one of the values for the duration of the power block; a second type of power block is encoded by changing between the values one time during the duration of the power block; and a first type of power block is encoded by changing between the values two or more times during the duration of the power block.

The third type of power block may be encoded by changing between the values at a rate of 8 kHz.

The third type of power block may be encoded by changing between the values seven times during the duration of the power block.

The second type of power block may be encoded by changing between the values at a rate of 2 kHz.

The duration of the power block may be about 500 microseconds.

Each of the data blocks and power blocks may be of the same time duration.

The controller may be configured to operate the resonance adjuster to adjust the resonant frequency of the receiver circuit by directing operation of the switching element.

The wireless power receiver may be configured to be in communication with a host for supplying power thereto, and receiving information therefrom relating to the data and power blocks. The power instructions may be based on power requirements of the host.

The signal may comprise a preamble immediately preceding the data and power blocks. The preamble may be of a predetermined length.

The high and low values may correspond to different resonant frequencies of a circuit configured to encode the digital signal.

According to additional aspects of the presently disclosed subject matter, there are provided any one or more of a wireless power receiver, a method for encoding a signal, a wireless power outlet, a method for decoding a signal, and a wireless power system, each substantially as described herein and illustrated in the accompanying drawings.

### BRIEF DESCRIPTION OF THE DRAWINGS

For a better understanding of the embodiments and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 is a schematic illustration of a wireless power system according to the presently disclosed subject matter;

FIG. 2 illustrates a digital signal used for transmitting messages between a wireless power receiver and a wireless power outlet of the wireless power system illustrated in FIG. 1; and

FIGS. 3A through 3E illustrate different types of power blocks of the digital signal illustrated in FIG. 2.

### DETAILED DESCRIPTION

Detailed embodiments are disclosed herein; however, it is to be understood that the disclosed embodiments are merely exemplary and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the embodiments.

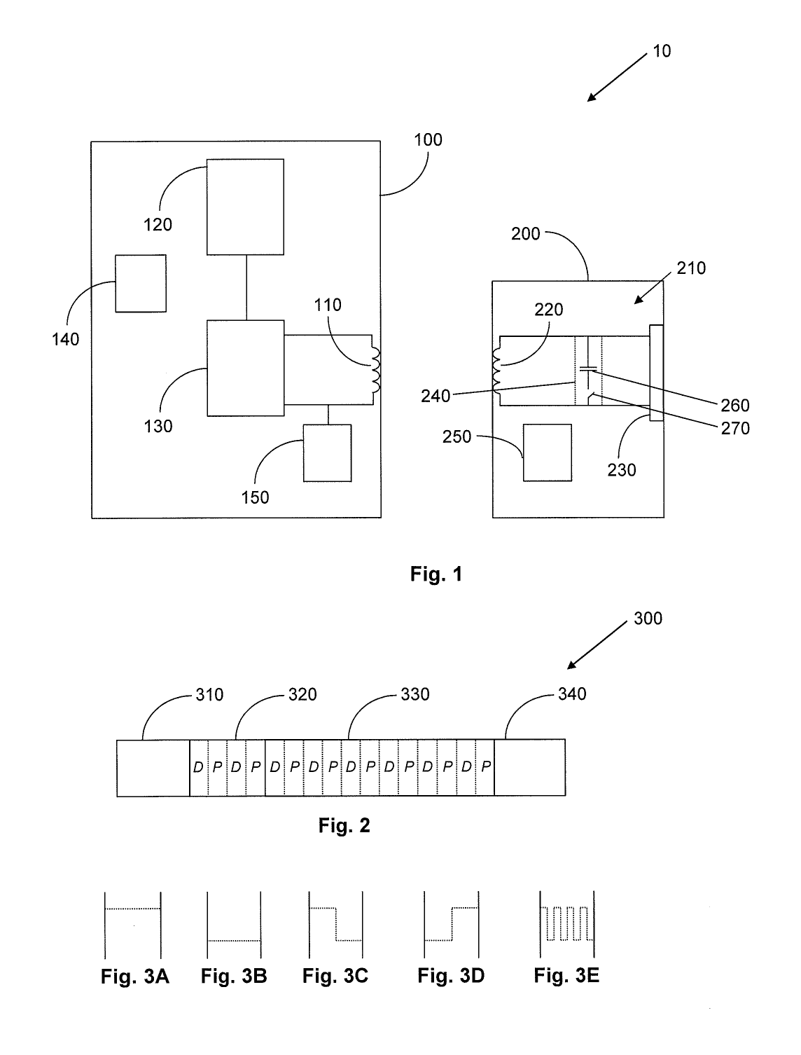

As illustrated in FIG. 1, there is provided a wireless power system 10, comprising a wireless power outlet 100 and a wireless power receiver 200.

The wireless power outlet 100, which may be an inductive power outlet, a resonant power outlet, or the like, constitutes an inductive transmitter adapted to transmit electrical power wirelessly to the wireless power receiver 200. Accordingly, the wireless power outlet 100 comprises a primary inductive coil 110 connected to a power source 120 via a driver 130. The driver 130 is configured to provide an oscillating driving voltage to the primary inductive coil 110. The wireless power outlet 100 further comprises an outlet controller 140, such as a microcontroller unit, to direct operation thereof.

The wireless power outlet 100 is further configured to detect a change in state from a high logic state to a low logic state effected by the wireless power receiver 200, for example a change in resonant frequency of a power receiver circuit of the wireless power receiver 200 when a secondary inductive coil thereof is inductively coupled with the primary inductive coil 100 (elements of the wireless power receiver will be described below). For this purpose, The wireless power outlet 100 may further comprise a voltage peak detector 150 configured to detect increases in the transmission voltage during use (changes in transmission voltage are affected by changes in the resonant frequency of the receiver circuit when inductively coupled with the wireless power outlet).

The wireless power receiver 200 is configured to operate with an electronic device (not illustrated; referred to herein as a “host”), such as a mobile telephone, a computer, a tablet, etc., and constitutes an inductive receiver thereof (Herein the specification and claims, the terms “receiver”, “wireless receiver”, “wireless power receiver”, and “wireless power receiver” may be used interchangeably with one another.) It may be functionally connected thereto using any suitable arrangement. According to one non-limiting example, the wireless power receiver may be embedded in the host. According to another non-limiting example, the wireless power receiver 200 may be implemented on external hardware, such as a card or module, configured to interface with the host for providing electrical power thereto, such as described in the applicant's co-pending United States Patent Publication Number US 2014/0302782, which is incorporated herein by reference in its entirety.

The wireless power receiver 200 comprises a receiver circuit, which is generally indicated at 210, comprising a secondary inductive coil 220 connected to a load 230, e.g., associated with or constituting part of the host, and a state modifier 240 electrically connected to the secondary inductive coil. The wireless power receiver 200 further comprises a receiver controller 250, such as a microcontroller unit, configured to direct operation thereof.

It will be appreciated that herein the specification and claims, any operation, function, etc., which is described as being carried out or performed by) either the wireless power outlet 100 or the wireless power receiver 200, may in fact be carried out or performed by one or more elements thereof, for example, respectively, the outlet controller 140 or the receiver controller 250, mutatis mutandis.

The secondary inductive coil 220 is configured to inductively couple with the primary inductive coil 110, thereby facilitating the receiver circuit 210 to draw power from the power source 120 via the primary inductive coil.

The state modifier 240 such as a resonance adjuster for example is configured electrically connected to the secondary inductive coil 220. For example, it may be connected in parallel thereto. By way of example only, a resonance adjuster may be configured to adjust the resonant frequency of the receiver circuit 210 by selectively modifying it. In order to accomplish this, it may comprise a circuit element 260 and a switching element 270 configured to selectively connecting/disconnecting the circuit element to/from the receiver circuit. The circuit element 260 may be any suitable element, including, but not limited to, a capacitor (as illustrated in FIG. 1), an inductor, or a resistor which may alter the natural frequency or the quality factor of the power receiver circuit so as to effect a change in state detectable at the wireless power outlet.

As will be appreciated by those having skill in the art that the resonant frequency of the receiver circuit with the circuit element 260 connected thereto is different from the resonant frequency thereof with the circuit element disconnected therefrom. The switching element 270 may be configured to be operated by the receiver controller 250, thereby enabling the receiver controller to adjust the resonant frequency of the receiver circuit 210. It will be further appreciated that other electrical components such as inductors or resistors and the like may adjust the quality factor or other circuit characteristics such that a state change may be detected.

The wireless power receiver 200 may be configured to transmit messages to the wireless power outlet 100. These messages may carry information, which may include, but is not limited to, some or all of manufacturer information, user information, software version information, etc., of the host and/or the wireless power receiver 200.

In addition, the messages may carry power instructions for the wireless power outlet 100, which may include, but are not limited to, an instruction for the wireless power outlet to increase its operating frequency (thereby decreasing the power transferred thereby), an instruction for the wireless power outlet to decrease its operating frequency (thereby increasing the power transferred thereby), and an instruction for the wireless power outlet to continue its operation without changing its operating frequency. (The instruction to increase may be an instruction to increment, and the instruction to decrease may be an instruction to decrement.) The power instructions may be based on power requirements of the host.

In order to transmit the message, the wireless power receiver 200 creates a digital signal which includes the information and the power instructions in a signal. The receiver controller 250 encodes the signal by adjusting the resonant frequency of the receiver circuit 210, for example as described above in connection with the state modifier 240, between a first and second state (e.g., each associated with the circuit element 260 being either connected or disconnected). The wireless power outlet 100 can infer the state of the receiver circuit 200 (or at least infer when a change therein occurs), for example resonant frequency may be detected using the peak voltage detector 150 thereof. Thus, the receiver controller 250 may construct a signal using each of the two states of the receiver circuit 210 to indicate “bits”.

As illustrated in FIG. 2, the signal 300 may comprise a preamble 310, a header 320, a payload 330, and a checksum 340. The header 320 and payload 330 may each be constructed having a plurality of data blocks (each indicated with by “D” in FIG. 2) alternating with a plurality of power blocks (each indicated with by “P” in FIG. 2). Data and power blocks are indicated by broken lines in FIG. 2, while the components of the signal 300 (i.e., the preamble 310, header 320, payload 330, and checksum 340) are indicated by solid lines. The data blocks may each carry information, for example as described above in connection with the transmission of messages from the wireless power receiver 200 to the wireless power outlet 100, and the power blocks each carry a power instruction as described above.

Each of the blocks may be any suitable length. For example, the power blocks may each have a length of about 500 microseconds. The data blocks may have the same or different length as the power blocks.

It will be appreciated that the illustration of the signal 300 in FIG. 2 is for illustrative purposes only, e.g., it may comprise any suitable number of data and power blocks. Likewise, the relative lengths of the different elements of the signal 300 are not to be construed as limiting.

The preamble 310 may be constructed according to any suitable design. The wireless power outlet 100 may be configured to use it to synchronize with incoming data and/or accurately detect the first data or power block. It may be of any length, for example between 11 and 25 bits, and may be constructed such that each bit has the same value, e.g., 1.

The header 320 may be constructed to indicate the type of information contained in the payload 330. It may further indicate the length of the payload 330.

According to some examples, only the data blocks of the header 320 include any information relevant thereto. Thus, the data blocks in the header 320 constitute a data header of the signal 300. Accordingly, the power blocks which are transmitted as part of the header 320 are ignored for header-related considerations (i.e., the wireless power receiver 200 does not encode any header information therein, and the wireless power outlet 100 does not construe the power blocks as containing any header information), and instead are treated as power instructions which the wireless power outlet may act on immediately. The wireless power outlet 100 may thus act in accordance with a power instruction transmitted by the wireless power outlet 200 immediately upon completion of the first power block. According to some modifications, it may act in accordance with a power instruction once enough of the power block has been transmitted that the type of power block can be unambiguously identified.

The data blocks of the payload 330 may include information, for example that listed above, which the wireless power receiver 200 transmits to the wireless power outlet 100. In addition, as described above, it comprises power blocks alternating with the data blocks. The data blocks in the payload 330 constitute a data payload of the signal 300.

The checksum 340 may be constructed according to any suitable design. The wireless power outlet 100 may be configured to use it to check for transmission errors, e.g., in the payload, and in particular in the data blocks thereof. According to some examples, it includes data blocks, which carry checksum information, alternating with power blocks.

It will be appreciated that the descriptions of the signal 300 above is to be construed as a feature of the outlet receiver 140, i.e., that of it being configured to decode and act on such a signal, and as a feature of the receiver controller 150, i.e., that of it being configured to construct and encode such a signal.

The data blocks may be constructed according to any suitable design. In addition, they may not contain any information (which may be indicated, e.g., in the header 320).

As illustrated in FIGS. 3A through 3E, each power block may be one of three different types, each of which indicates a different type of power instruction. In each of FIGS. 3A through 3E, the solid vertical lines indicate the beginning and end of the power block, and the broken line indicates the value of the signal, i.e., the two “heights” of the vertical lines represent two different resonant frequencies of the receiver circuit 210.

For example, as illustrated in FIGS. 3A and 3B, a first type of power block may be encoded by the wireless power receiver 200 by keeping the resonant frequency of the receiver circuit 210 constant for the duration of the power block, either at a “high” state value as in FIG. 3A, or as a “low” state value as in FIG. 3B (each of the different types of bits being associated with a different pattern of the resonant frequency of the receiver circuit).

As illustrated in FIGS. 3C and 3D, a second type of power block may be encoded by the wireless power receiver 200 changing the resonant frequency of the receiver circuit 210 between its two resonant frequencies one time during the duration of the power block, either from a “high” value to a “low” value as in FIG. 3C, or as a “low” value to a “high” value as in FIG. 3D; thus, the power block includes one transmission of a “high” value, and one transmission of a “low” value. This change may occur about halfway through the duration of the power block, i.e., the length of each bit may be the same. According to the example above, wherein the length of each power block is about 500 microseconds, the change between the two values of resonant frequency may occur at about 250 microseconds. The change between these two frequencies thus occurs at a rate of 2 kHz.

As illustrated in FIG. 3E, a third type of power block may be encoded by the wireless power receiver 200 changing the resonant frequency of the receiver circuit 210 between its two resonant frequencies seven times during the duration of the power block; thus, the power block includes fours transmissions of a “high” value, alternating with four transmissions of a “low” value. The power block may begin with either a “high” value or a “low” value of resonant frequency. The length of each bit may be the same. According to the example above, wherein the length of each power block is about 500 microseconds, each two values of resonant frequency may have a length of about 125 microseconds. The change between these two frequencies thus occurs at a rate of 8 kHz.

The wireless power receiver 200 may use each of the types of bits to transmit a different power instruction to the wireless power outlet 100. For example, it may transmit a power instruction for the wireless power outlet to increase its operating frequency using the first type of power block, a power instruction for the wireless power outlet to continue its operation without changing its operating frequency using the second type of power block, and a power instruction for the wireless power outlet to decrease its operating frequency using the third type of power block.

Similarly, the wireless power outlet is configured to decode the signals 300 detected accordingly, and to take appropriate action (e.g., to change its operating frequency upon receipt of a suitable power block).

Those skilled in the art to which this invention pertains will readily appreciate that numerous changes, variations and modifications can be made without departing from the scope of the invention mutatis mutandis.

Technical and scientific terms used herein should have the same meaning as commonly understood by one of ordinary skill in the art to which the disclosure pertains. Nevertheless, it is expected that during the life of a patent maturing from this application many relevant systems and methods will be developed. Accordingly, the scope of the terms such as computing unit, network, display, memory, server and the like are intended to include all such new technologies a priori.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

As used herein, the singular form “a”, “an” and “the” may include plural references unless the context clearly dictates otherwise. For example, the term “a compound” or “at least one compound” may include a plurality of compounds, including mixtures thereof.

The word “optionally” is used herein to mean “is provided in some embodiments and not provided in other embodiments”. Any particular embodiment of the disclosure may include a plurality of “optional” features unless such features conflict.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. It should be understood, therefore, that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6 as well as non-integral intermediate values. This applies regardless of the breadth of the range.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the disclosure.

While exemplary embodiments are described above, it is not intended that these embodiments describe all possible forms of the claimed subject matter. Rather, the words used in the specification are words of description rather than limitation, and it is understood that various changes may be made without departing from the spirit and scope of the disclosure. Additionally, the features of various implementing embodiments may be combined to form further embodiments not explicitly described or illustrated.

1-101. (canceled)

102. A wireless power receiver configured to inductively receive power from a wireless power outlet for powering a load, and configured to encode a signal for detection by said wireless power outlet, said wireless power receiver comprising a receiver circuit having:
a secondary coil connected to said load and configured to receive power from a primary coil associated with said wireless power outlet; and
a state modifier electrically connected to said secondary coil and configured to adjust a circuit characteristic of the receiver circuit, between one of two states, by selectively modifying the receiver circuit;
said wireless power receiver further comprising a controller configured to operate said state modifier to encode said signal by adjusting the circuit characteristic of the receiver circuit, wherein said signal comprises a plurality of data blocks carrying information, alternating with a plurality of power blocks each carrying a power instruction.

103. The wireless power receiver according to claim 102, wherein each of said power instructions is selected from the group consisting of:
to increase the operating frequency of the wireless power outlet;
to decrease the operating frequency of the wireless power outlet; and
to continue operation of the wireless power outlet with no change in operating frequency.

104. The wireless power receiver according to claim 102, wherein said controller is configured to:
operate said state modifier to encode a first type of power block by keeping circuit characteristic of the receiver circuit constant for the duration of the power block;
operate said state modifier to encode a second type of power block by changing the circuit characteristic of the receiver circuit between said two circuit characteristics one time during the duration of the power block; and
operate said state modifier to encode a third type of power block by changing the circuit characteristic of the receiver circuit between said two circuit characteristics two or more times during the duration of the power block.

105. The wireless power receiver according to claim 104, wherein said controller is configured to operate said state modifier to encode said third type of power block by changing the circuit characteristic of the receiver circuit between said two circuit characteristics at a rate of 8 kHz.

106. The wireless power receiver according to claim 104, wherein said controller is configured to operate said state modifier to encode said third type of power block by changing the circuit characteristic of the receiver circuit between said two circuit characteristics seven times during the duration of the power block.

107. The wireless power receiver according to claim 104, wherein said controller is configured to operate said state modifier to encode said second type of power block by changing the circuit characteristic of the receiver circuit between said two circuit characteristics at a rate of 2 kHz.

108. The wireless power receiver according to claim 102, wherein the duration of the power block is about 500 microseconds.

109. The wireless power receiver according to claim 102, wherein each of said data blocks and power blocks is of the same time duration.

110. The wireless power receiver according to claim 102, wherein said state modifier comprises a circuit element and a switching element configured to modify the receiver circuit by selectively connecting/disconnecting said circuit element to/from said receiver circuit, thereby adjusting the circuit characteristic thereof.

111. The wireless power receiver according to claim 110, wherein said circuit element is selected from the group consisting of a resistor, a capacitor, and an inductor.

112. The wireless power receiver according to claim 110, wherein said controller is configured to operate said state modifier to adjust the circuit characteristic of the receiver circuit by directing operation of said switching element.

113. The wireless power receiver according to claim 102, configured to be in communication with a host for supplying power thereto, and receiving information therefrom relating to said data and power blocks.

114. The wireless power receiver according to claim 113, wherein said power instructions are based on power requirements of said host.

115. The wireless power receiver according to claim 102, wherein said signal comprises a preamble immediately preceding said data and power blocks.

116. The wireless power receiver according to claim 115, wherein said preamble is of a predetermined length.

117. A method of encoding a signal, the method comprising:
providing a wireless power receiver having a receiver circuit comprising a resonance adjuster configured to adjust the resonant frequency of the receiver circuit, between one of two resonant frequencies, by selectively modifying the receiver circuit; and
encoding said signal by operating the resonance adjuster to adjust the resonant frequency of the receiver circuit;
wherein said signal comprises a plurality of data blocks carrying information alternating with a plurality of power blocks each carrying a power instructions.

118. A digital signal encoded using high and low values, the digital signal comprising a plurality of data blocks carrying information, alternating with a plurality of power blocks each carrying a power instruction for a wireless power outlet.

119. The digital signal according to claim 118, wherein each of said power instructions is selected from the group consisting of:
to increase the operating frequency of the wireless power outlet;
to decrease the operating frequency of the wireless power outlet; and
to continue operation of the wireless power outlet with no change in operating frequency.

120. The digital signal according to any one of claim 118, wherein:
a first type of power block is encoded by transmitting one of said values for the duration of the power block;
a second type of power block is encoded by changing between said values one time during the duration of the power block; and
a first type of power block is encoded by changing between said values two or more times during the duration of the power block.

121. The digital signal according to claim 120, wherein said third type of power block is encoded by changing between said values at a rate of 8 kHz.
